(19) United States
(12) Patent Application Publication
(10) Pub. No.: US 2025/0202302 A1
(43) Pub. Date: Jun. 19, 2025

(54) ROTOR

(71) Applicant: ACCELERATED SYSTEMS INC., Waterloo (CA)

(72) Inventor: Stanley BAER, Kitchener (CA)

(21) Appl. No.: 18/975,576

(22) Filed: Dec. 10, 2024

Related U.S. Application Data
(60) Provisional application No. 63/611,601, filed on Dec. 18, 2023.

(51) Int. Cl. H02K 1/2791

(52) U.S. Cl. CPC H02K 1/2791; H02K 2213/03

(57) ABSTRACT

There is provided a rotor for an electric motor, the rotor having a side wall rotatable about an axis of rotation of a shaft of the electric motor. The side wall has an inner surface. The side wall may support one or more magnets disposed proximate the inner surface. Moreover, the side wall may define a space to at least partially receive a stator of the electric motor. Furthermore, the side wall has a plurality of grooves in the inner surface. The grooves may be oriented about circumferentially relative to the axis of rotation.

### CROSS-REFERENCE TO RELATED APPLICATION

This application claims the benefit of, and priority from, U.S. Provisional Patent Application No. 63/611,601, filed on Dec. 18, 2023, which is incorporated herein by reference in its entirety.

### FIELD

The present specification relates to rotors, and in particular to rotors for electric motors.

### BACKGROUND

Many devices have movable components. Examples of such devices may include motors, and the like. Motors may have movable components such as rotatable shafts, rotors, and the like.

### SUMMARY

An aspect of the present specification provides a rotor for an electric motor, the rotor comprising: a side wall rotatable about an axis of rotation of a shaft of the electric motor, the side wall having an inner surface, the side wall to support one or more magnets disposed proximate the inner surface, the side wall defining a space to at least partially receive a stator of the electric motor, the side wall comprising a plurality of grooves in the inner surface, the grooves being oriented about circumferentially relative to the axis of rotation.

One or more of the grooves may each define a corresponding plane about perpendicular to the axis of rotation.

One or more of the grooves may each define a corresponding plane forming an angle of more than about 45 degrees and less than about 90 degrees to the axis of rotation.

One or more of the grooves may each define a closed loop.

The grooves may be helical.

The grooves may be about equally spaced from one another along the axis of rotation.

The grooves may be about evenly distributed along a height of the side wall measured along the axis of rotation.

The grooves may take up a fraction of the height of the side wall, the height measured along the axis of rotation, the fraction being less than or equal to about 10%.

The side wall may have a thickness measured radially relative to the axis of rotation, and one or more of the grooves each have a corresponding depth being at most about 40% of the thickness of the side wall.

The one or more of the grooves may each have the corresponding depth being at most about 30% of the thickness of the side wall.

The one or more of the grooves may each have the corresponding depth being at most about 20% of the thickness of the side wall.

The one or more of the grooves may each have the corresponding depth being at most about 10% of the thickness of the side wall.

The one or more of the grooves may have a corresponding aspect ratio being less than or equal to about 1:1, the aspect ratio being a ratio of a corresponding width of a given groove measured along the axis of rotation to a corresponding depth of the given groove measured radially relative to the axis of rotation.

The one or more of the grooves may have the corresponding aspect ratio being less than or equal to about 1:3.

The one or more of the grooves may have the corresponding aspect ratio being less than or equal to about 1:10.

One or more of the grooves may each have a shape being one of about rectangular, about V-shaped, and about U-shaped.

The inner surface of the side wall may define a cylinder.

The side wall may comprise a backiron of the electric motor.

The side wall may be to support the one or more magnets being permanent magnets.

One or more of the grooves may be at least partially filled with a material having a magnetic permeability being lower than a corresponding magnetic permeability of the side wall.

According to another implementation of the present specification there is provided a rotor assembly for an electric motor, the rotor assembly comprising: the rotor described herein; and the one or more magnets disposed proximate the inner surface of the side wall.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 shows a perspective view of an example rotor, in accordance with a non-limiting implementation of the present specification.

FIG. 2 shows a perspective view of an example rotor assembly, in accordance with a non-limiting implementation of the present specification.

FIG. 3 shows a top plan view of the rotor of FIG. 1.

FIG. 4 shows a cross-sectional view of the rotor of FIG. 1.

FIG. 5 shows a top plan view of the rotor assembly of FIG. 2.

FIG. 6 shows a cross-sectional view of the rotor assembly of FIG. 2.

FIG. 7 shows a magnified portion of the cross-sectional view shown in FIG. 6.

FIG. 8 shows a magnified portion of the cross-sectional view shown in FIG. 4.

FIG. 9 shows a schematic representation of example groove shapes, in accordance with a non-limiting implementation of the present specification.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, and the like.

Moreover, in the following description, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, ZZ, and the like). Similar logic can be applied for two or more items in any occurrence of “at least one . . . ” and “one or more . . . ” language.

Unless the context requires otherwise, throughout the specification and claims which follow, the word “comprise” and variations thereof, such as, “comprises” and “comprising” are to be construed in an open, inclusive sense, that is as “including, but not limited to.”

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

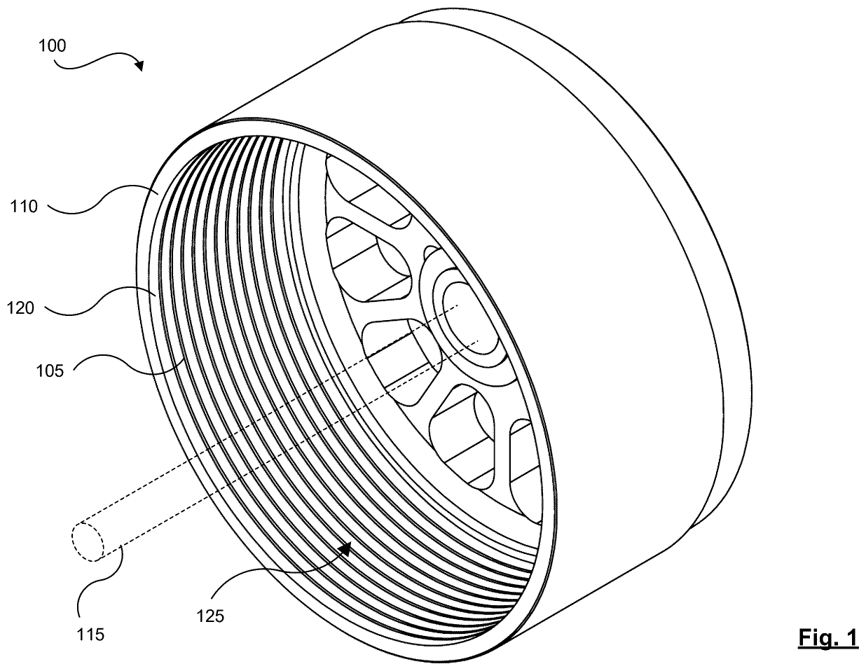

Some motors are electric motors. Some such motors may have a rotor and a stator. In some electric motors, one or more magnets may be secured to the rotor, to form a rotor assembly. In some examples, these magnets may comprise permanent magnets. When such a rotor rotates during the operation of the electric motor, parasitic eddy currents may form in the rotor. Such eddy currents may undermine or degrade the performance of the electric motor. As such, reducing the magnitude of the eddy currents may improve the efficiency or performance of the electric motor. In some examples, structural features of the rotor may perform the function of reducing the parasitic eddy currents. FIG. 1 shows a perspective view of an example rotor 100 having grooves 105, which grooves may reduce the parasitic eddy currents in rotor 100 in operation.

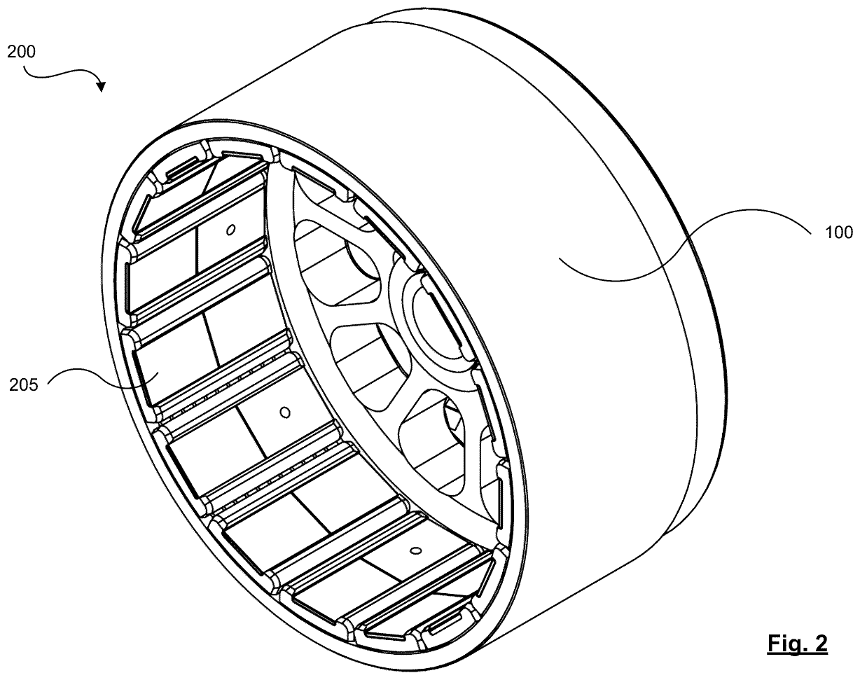

Rotor 100 comprises a side wall 110 rotatable about an axis of rotation of a shaft 115 of an electric motor. In FIG. 1 shaft 115 is shown in dashed lines to signify that while shaft 115 may be a component of an electric motor, shaft 115 need not be a component of rotor 100. The axial axis, or the long axis, of shaft 115 defines the axis of rogation of shaft 115 as well as the axis of rotation of rotor 100. Side wall 110 has an inner surface 120. Side wall 110 may support one or more magnets, such as magnets 205 shown in FIG. 2, proximate inner surface 120. In some examples, magnets 205 may comprise permanent magnets. Rotor 100 together with magnets 205 disposed proximate inner surface 120 may form a rotor assembly 200. In some examples, magnets 205 may be adjacent to, touching, or abutting inner surface 120 of side wall 110 of rotor 100. Moreover, in some examples, magnets 205 may be directly or indirectly secured to inner surface 120 of side wall 110 of rotor 100.

Referring back to FIG. 1, side wall 110 defines a space 125 to at least partially receive a stator of an electric motor incorporating rotor 100. This stator is not shown in FIG. 1. In motor designs where the stator is at least partially received in a space defined by the rotor, the rotor may be described as an outer rotor. As such, rotor 100 may be described as an outer rotor, in the context of the components of an electric motor. Furthermore, in the context of an electric motor, side wall 110 may comprise, or may be described as being or forming a part of, the backiron of the electric motor. Moreover, inner surface 120 of side wall 110 defines a cylinder. It is also contemplated that in some examples, the inner surface of the side wall may form or define a shape other than a cylinder.

As shown in FIG. 1, side wall 110 comprises a plurality of grooves 105 in inner surface 120 of side wall 110. Grooves 105 are oriented about circumferentially relative to the axis of rotation. In FIG. 1, grooves 105 each define a corresponding plane about perpendicular to the axis of rotation. It is also contemplated that in some examples, one or more of the grooves may each define a corresponding plane forming an angle of more than about 45 degrees and less than about 90 degrees to the axis of rotation. Moreover, as shown in FIG. 1, each of the grooves 105 defines a closed loop. It is also contemplated that in some examples the grooves need not define one or more closed loops; for example, the grooves may form open loops, may be helical, and the like.

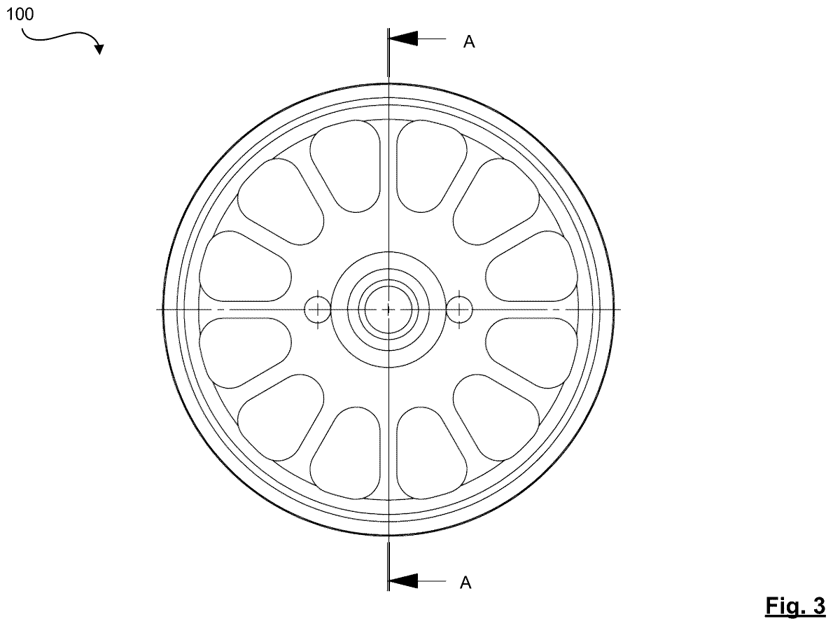

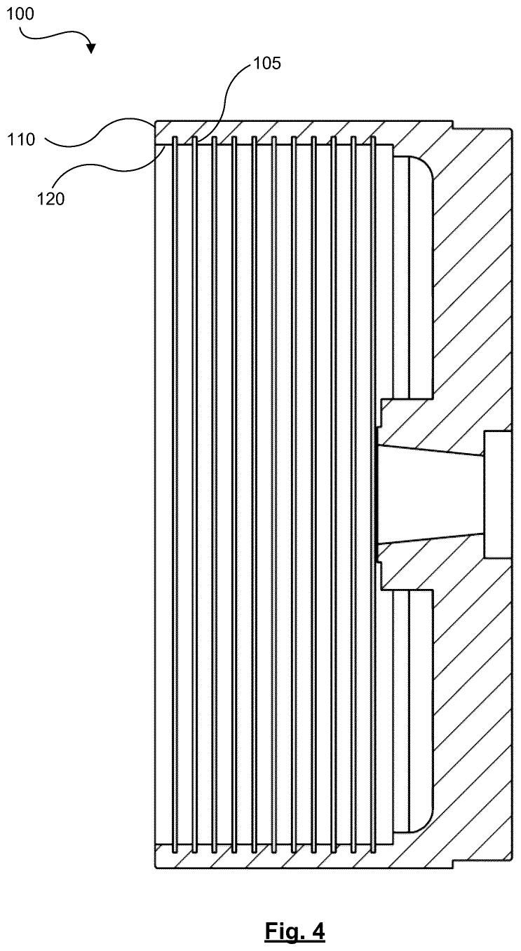

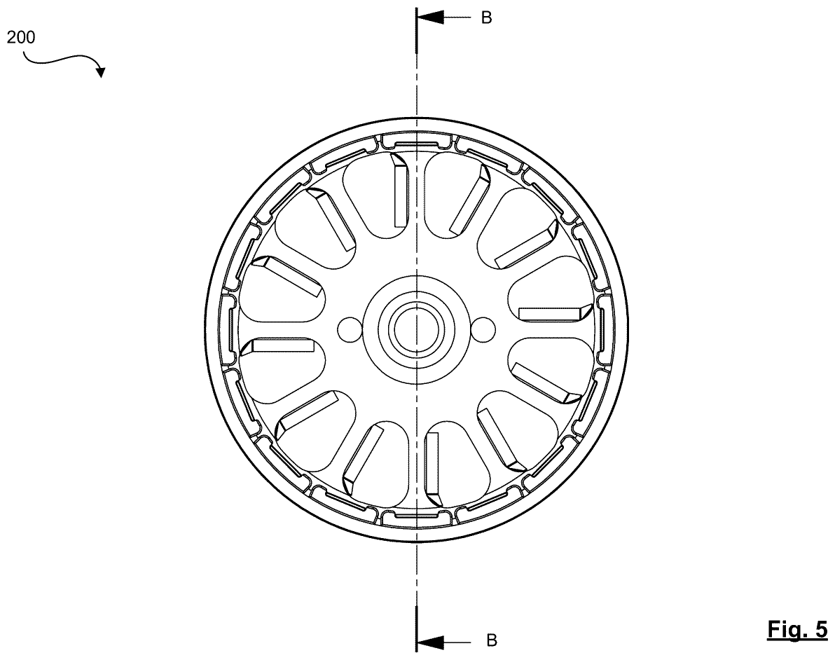

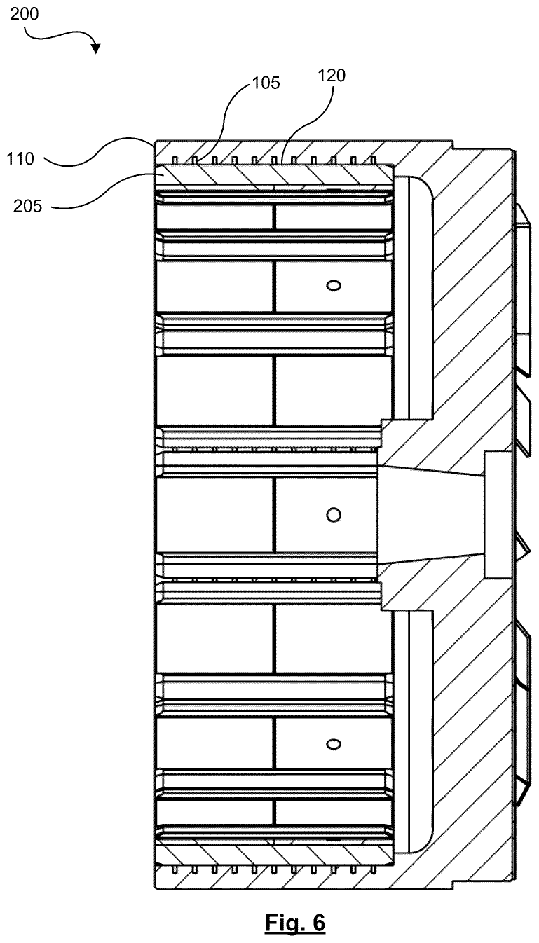

As discussed above, FIG. 2 shows a perspective view of example rotor assembly 200. FIG. 3 shows a top plan view of rotor 100. FIG. 4 shows a cross-sectional view of rotor 100 taken along line A-A shown in FIG. 3. FIG. 5, in turn, shows a top plan view of example rotor assembly 200. Moreover, FIG. 6 shows a cross-sectional view of rotor assembly 200 taken along line B-B shown in FIG. 5.

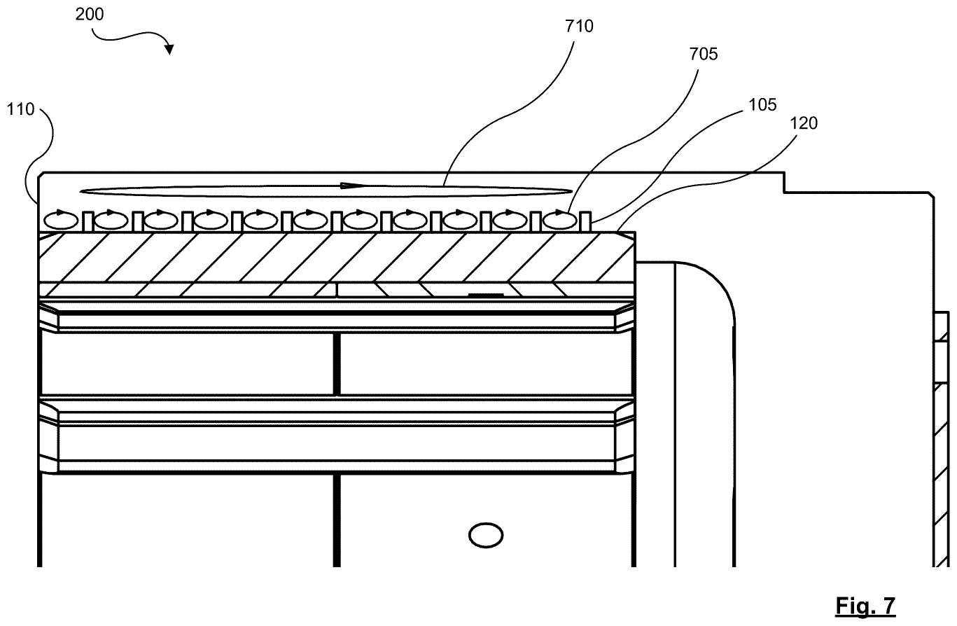

Turning now to FIG. 7, a magnified portion is shown of the cross-sectional view of rotor assembly 200 shown in FIG. 6. FIG. 7 shows loops 705 and 710 representing the parasitic eddy currents in side wall 110. In the absence of grooves 105, these eddy currents would have a relatively larger magnitude, as represented by the relatively larger loop 710. Near inner surface 120, grooves 105 interfere with, and reduce, the formation of eddy currents, such that near inner surface 120 the eddy currents are represented by relatively smaller loops 705. Since in operation parasitic eddy currents can be relatively large near inner surface 120, adding grooves 105 in inner surface 120 can reduce the magnitude of these parasitic eddy currents, thereby improving the efficiency or performance of an electric motor incorporating rotor assembly 200.

The deeper and wider the grooves are, the more they may hinder parasitic eddy currents. It may also be desirable to preserve a certain amount of magnetic material in the side wall to allow it to perform its functions as the backiron of the electric motor. In addition, the rotor and its side wall may rotate at relatively high speeds during the operation of the electric motor. Therefore, it may be desirable to preserve sufficient structural material and integrity in the side wall to all it to safely withstand the forces exerted on it during the operation of the electric motor. As such, the shape and size of the grooves, and their number, position, and distribution in the side wall may be selected to balance parasitic eddy current suppression with preserving the structural integrity of the side wall and its magnetic properties as the backiron of the electric motor.

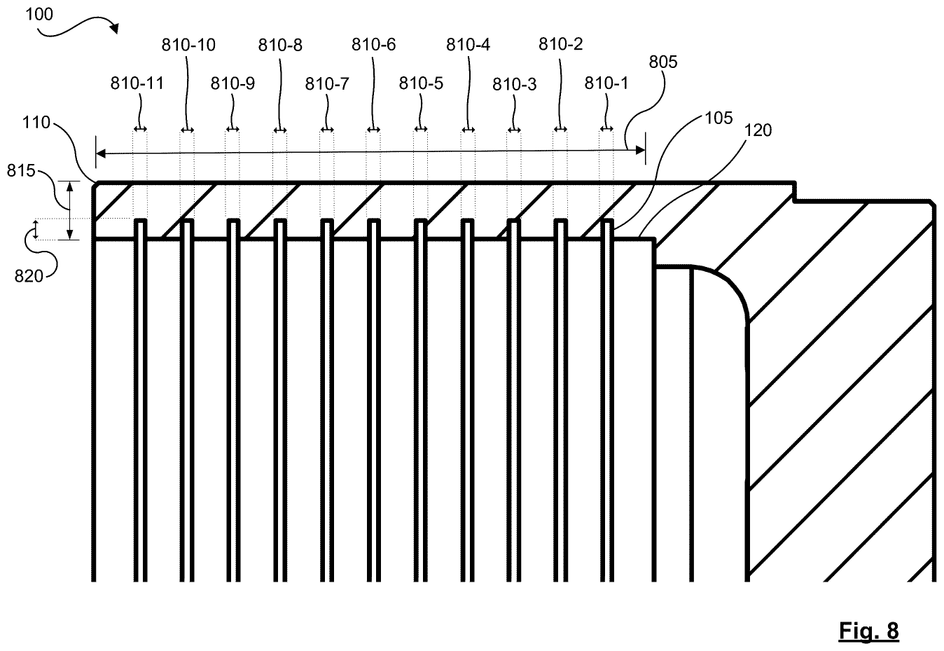

Turning now to FIG. 8, a magnified portion is shown of the cross section of rotor 100 shown in FIG. 4. FIG. 8 shows side wall 110 as having a height 805 measured along the axis of rotation. Side wall 110 also has a thickness 815 measured radially relative to the axis of rotation. Grooves 105, in turn, each have a width 810-1, 810-2, 810-3, 810-4, 810-5, 810-6, 810-7, 810-8, 810-9, 810-10, and 810-11 measured along the axis of rotation. Groove widths 810-1, 810-2, 810-3, 810-4, 810-5, 810-6, 810-7, 810-8, 810-9, 810-10, and 810-11 may be generically referred to as width 810, and collectively referred to as width 810-total. Moreover, grooves 105 may each have a depth 820, also measured radially relative to the axis of rotation.

In some examples, grooves 105 may be about equally spaced from one another along the axis of rotation. Moreover, in some examples, grooves 105 may be about evenly distributed along height 805 of side wall 110. Furthermore, in some examples, grooves 105 may take up a fraction of height 805 of side wall 110, the fraction being less than or equal to about 10%. In other words, in such examples, the ratio of width 810-total to height 805 may be less than or equal to about 10%.

In addition, in some examples, depth 820 of grooves 105 may be at most about 40% of thickness 815 of side wall 110. In some examples, depth 820 of grooves 105 may be at most about 30% of thickness 815 of side wall 110. Furthermore, in some examples, depth 820 of grooves 105 may be at most about 20% of thickness 815 of side wall 110. Moreover, in some examples, depth 820 of grooves 105 may be at most about 10% of thickness 815 of side wall 110.

The shape of grooves 105 may be defined in terms of an aspect ratio being a ratio of width 810 of a given groove 105 to the depth 820 of that groove. In some examples, this aspect ratio may be less than or equal to about 1:1. Moreover, in some examples, this aspect ratio may be less than or equal to about 1:3. Furthermore, in some examples, this aspect ratio may be less than or equal to about 1:10. Other shapes, sizes, aspect ratios, numbers, positions, orientations, and distributions of the grooves are also contemplated.

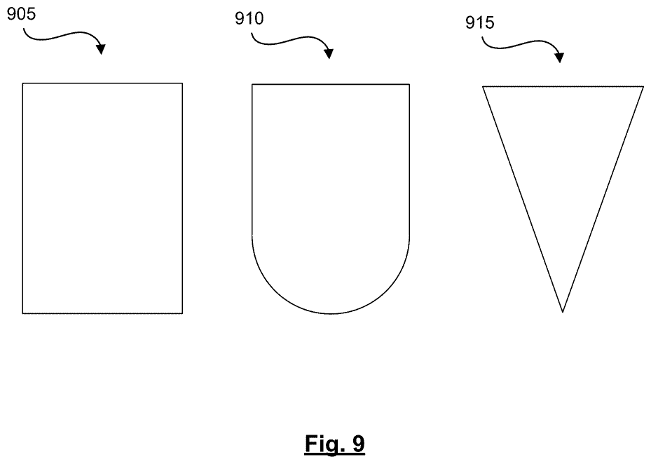

Grooves 105 shown in FIGS. 1-8 have a rectangular shape. It is contemplated that in some examples, the grooves may have a different shape. FIG. 9 shows a schematic representation of example groove shapes. FIG. 9 shows a rectangular groove shape 905, a U-shaped groove shape 910, and a V-shaped groove shape 915. Other shapes for grooves are also contemplated.

As described above, the grooves in the inner surface of the side wall may interfere with and reduce parasitic eddy currents. In some examples, this interference may be based on the grooves, or more specifically the material filling the grooves, having lower magnetic permeability or electrical conductivity than the material of the side wall of the rotor. When the grooves are simply carved out of the side wall of the rotor, in operation the grooves may be filled with air. During operation of the electric motor, such grooves may be filled with the ambient atmosphere or material in which the electric motor operates.

It is also contemplated that in some examples, one more of the grooves may be at least partially filled with a material having a magnetic permeability, or electrical conductively, that is lower than the corresponding magnetic permeability or electrical conductively of the side wall respectively. In some examples, this filling material may also enhance the mechanical properties or structural integrity of the grooved side walls of the rotor. Examples of such filling materials may include resins, cements, ceramics, and the like.

Throughout this specification and the appended claims, infinitive verb forms are often used. Examples include, without limitation: “to support,” and the like. Unless the specific context requires otherwise, such infinitive verb forms are used in an open, inclusive sense, that is as “to, at least, support,” and so on.

The above description of illustrated example implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. Moreover, the various example implementations described herein may be combined to provide further implementations.

In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A rotor for an electric motor, the rotor comprising:
a side wall rotatable about an axis of rotation of a shaft of the electric motor, the side wall having an inner surface, the side wall to support one or more magnets disposed proximate the inner surface, the side wall defining a space to at least partially receive a stator of the electric motor, the side wall comprising a plurality of grooves in the inner surface, the grooves being oriented about circumferentially relative to the axis of rotation.

2. The rotor of claim 1, wherein one or more of the grooves each define a corresponding plane about perpendicular to the axis of rotation.

3. The rotor of claim 1, wherein one or more of the grooves each define a closed loop.

4. The rotor of claim 1, wherein the grooves are about equally spaced from one another along the axis of rotation.

5. The rotor of claim 1, wherein the grooves are about evenly distributed along a height of the side wall measured along the axis of rotation.

6. The rotor of claim 1, wherein the grooves take up a fraction of a height of the side wall, the height measured along the axis of rotation, the fraction being less than or equal to about 10%.

7. The rotor of claim 1, wherein the side wall has a thickness measured radially relative to the axis of rotation, and one or more of the grooves each have a corresponding depth being at most about 40% of the thickness of the side wall.

8. The rotor of claim 7, wherein the one or more of the grooves each have the corresponding depth being at most about 30% of the thickness of the side wall.

9. The rotor of claim 8, wherein the one or more of the grooves each have the corresponding depth being at most about 20% of the thickness of the side wall.

10. The rotor of claim 9, wherein the one or more of the grooves each have the corresponding depth being at most about 10% of the thickness of the side wall.

11. The rotor of claim 1, wherein one or more the grooves have a corresponding aspect ratio being less than or equal to about 1:1, the aspect ratio being a ratio of a corresponding width of a given groove measured along the axis of rotation to a corresponding depth of the given groove measured radially relative to the axis of rotation.

12. The rotor of claim 11, wherein the one or more of the grooves have the corresponding aspect ratio being less than or equal to about 1:3.

13. The rotor of claim 12, wherein the one or more of the grooves have the corresponding aspect ratio being less than or equal to about 1:10.

14. The rotor of claim 1, wherein one or more of the grooves each have a shape being one of about rectangular, about V-shaped, and about U-shaped.

15. The rotor of claim 1, wherein the inner surface of the side wall defines a cylinder.

16. The rotor of claim 1, wherein the side wall comprises a backiron of the electric motor.

17. The rotor of claim 1, wherein the side wall is to support the one or more magnets being permanent magnets.

18. The rotor of claim 1, wherein one or more of the grooves are at least partially filled with a material having a magnetic permeability being lower than a corresponding magnetic permeability of the side wall.

19. A rotor assembly for an electric motor, the rotor assembly comprising:
the rotor of claim 1; and
the one or more magnets disposed proximate the inner surface of the side wall.
